(19) United States
(12) Patent Application Publication
(10) Pub. No.: US 2016/0073168 A1
(43) Pub. Date: Mar. 10, 2016

(54) CHANNEL OF TOP SOCIALLY-COMMENTED AUDIO VISUAL CONTENT

(71) Applicant: Cisco Technology, Inc., San Jose, CA (US)

(72) Inventors: Laurent GARDES, Meudon (FR); Yann PRAT, Elancourt (FR); Didier DE MARREZ, Charenton-le-Pont (FR); Olivier LACOUR, Paris (FR)

(21) Appl. No.: 14/811,865

(22) Filed: Jul. 29, 2015

Related U.S. Application Data
(60) Provisional application No. 62/048,200, filed on Sep. 9, 2014.

(51) Int. Cl. H04N 21/4788; H04N 21/488; H04N 21/234

(52) U.S. Cl. CPC H04N 21/4788; H04N 21/23424; H04N 21/4888

(57) ABSTRACT

In one embodiment, a method for providing access to a content delivery channel for presentation on a viewing device includes: receiving statistics about comments published on a social media platform, the comments being identified as relevant to a plurality of media content instances broadcast during a given period of time; processing the received statistics to determine the most commented upon media content instances on the social media platform; using the processed statistics to identify one or more highlights in each of the most commented upon media content instances; and constructing a content delivery channel, wherein the content delivery channel comprises audio-visual (AV) content corresponding to the identified one or more highlights.

### CROSS-REFERENCE TO RELATED APPLICATION

This application claims priority to U.S. Provisional Application No. 62/048,200, filed Sep. 9, 2014, the complete disclosure of which is incorporated herein by reference in its entirety.

### TECHNICAL FIELD

The present disclosure generally relates to methods and apparatus to generate a channel based on the most socially commented audio-visual content.

### BACKGROUND

Social media platforms enable users to easily share contents and/or publish comments. Advances in the television industry have challenged the television platform operators and/or television broadcasters to develop new solutions to take advantage of the increasing popularity of these new platforms. As a result new functionalities have been implemented and are now available to television end users. Typically, television end users are now able to access and interact with their favorite social media platforms directly via their television sets.

### BRIEF DESCRIPTION OF THE DRAWINGS

The present invention will be understood and appreciated more fully from the following detailed description, taken in conjunction with the drawings in which:

FIG. 1 is a block diagram illustration of a system, constructed and operative in accordance with an embodiment of the present invention;

FIG. 2 is a block diagram illustration of a content delivery channel generator, constructed and operative in accordance with an embodiment of the present invention;

FIG. 3 is a flow chart diagram illustrating a method for generating the content delivery channel according to embodiments of the present invention;

FIG. 4 is a graphical illustration showing different distributions of commentaries for different media content instances in accordance with an embodiment of the present invention;

FIG. 5 is a graphical illustration showing a peak of a graphical representation of the distribution of the commentaries in accordance with an embodiment of the present invention;

FIGS. 6 is a pictorial illustration of the content delivery channel line-up, constructed and operative in accordance to embodiments of the present invention;

FIGS. 7 is a pictorial illustration of a playlist for the content delivery channel, constructed and operative in accordance with embodiments of the present invention;

FIG. 8A is a pictorial illustration of a user interface for accessing the content delivery channel, in accordance with an embodiment of the present invention; and

FIGS. 8B and 8C are pictorial illustrations of user interfaces showing the content delivery channel line-up and/or playlist, in accordance with embodiments of the present invention.

### DESCRIPTION OF EXAMPLE EMBODIMENTS

### Overview

In one embodiment, a method for providing access to a content delivery channel for presentation on a viewing device, includes: receiving statistics about comments published on a social media platform, the comments being identified as relevant to a plurality of media content instances broadcast during a given period of time; processing the received statistics to determine the most commented upon media content instances on the social media platform; using the processed statistics to identify one or more highlights in each of the most commented upon media content instances; and constructing a content delivery channel, wherein the content delivery channel comprises audio-visual (AV) content corresponding to the identified one or more highlights.

### DETAILED DESCRIPTION OF EXEMPLARY EMBODIMENTS

In the following description, numerous specific details are set forth in order to provide a thorough understanding of the various principles of the present invention. However, those skilled in the art will appreciate that not all these details are necessarily always required for practicing the present invention. In this instance, well-known circuits, control logic, and the details of computer program instructions for conventional algorithms and processes have not been shown in detail in order not to obscure the general concepts unnecessarily.

Although the principles of the present invention are largely described herein in relation to a television broadcast environment and related television applications, this is an example selected for convenience of presentation, and is not limiting.

The disclosed technology addresses the need in the art for a system that is able to filter meaningful statistics from social media platforms to facilitate the generation of a content delivery channel that presents the highlights of recently broadcast media content and/or other audio-visual content. Media content for the content delivery channel is selected as being among the highlights based on the aggregated reaction of audience members that are active on a social media platform during broadcasting of the media content. Related methods for filtering the statistics from social networks and generating the content delivery channel are also disclosed.

Reference is now made to FIG. 1, which is a block diagram illustration of a system 100, constructed and operative in accordance with an embodiment of the present invention. As it will be described in more detail below, system 100 may be configured to facilitate access by a user to a content delivery channel which presents portions of recently broadcast media content instances the most commented on social media networks. System 100 may include, but is not limited to, a social media platform 110, a headend 120, a client device 130, a display device 140 associated with the client device 130 and a network 150.

Social media platform 110 may be configured to manage (e.g. maintain, process, distribute and/or generate) a platform enabling users to publish any type of comments on a wide range of topics, including comments about media content provided a headend 120. In addition, the social media platform 110 is operable to transmit statistics relevant to the comments associated with media content provided by a headend 120 to the headend 120. Although the embodiments below will be largely described with reference to Twitter as the social media platform 110, those skilled in the art will realize that any social media platform, including but not limited to Facebook, Google+, etc. may be the source, alone or in combination, of the social media commentaries and statistics.

Headend 120 may be configured to manage (e.g. maintain, process, distribute and/or generate) media content for presentation to one or more users of client device 130. As used herein, “media content” may refer to any content under the control of the headend 120 and accessible via a client device 130. For example, media content includes, but is not limited to, any television program, on-demand media program (e.g., video-on-demand program), pay-per-view event, broadcast media program (e.g., broadcast television program), multicast media program, advertisement. IPTV media content, or any other form of AV content that may be viewed or otherwise experienced by a user of client device 130. The headend 120 is operable to request and receive statistics relevant to the media content from the social media platform 110. The headend 120 is further operable to process the statistics in order to identify the most commented upon media content instances on the social media platform 110. The headend 120 is further configured to generate a channel (hereinafter referred as the content delivery channel) including portions of media content instances identified as the most commented upon on the social media platform 110 and make it available to one or more users of client device 130.

Client device 130 may be configured to facilitate access by a user to media content and to the content delivery channel provided by the headend 120 and/or any other data provided by the headend 120 or social media platform 110. Client device 130 may be for example, but not limited to, a set-top box disposed in use between the headend 120 and a display device 140. Although depicted as separate devices, client device 130 and display device 140 may be combined in a single device as long as the single device is operable to process and present media content and the content delivery channel to one or more users. Such a single device may be for example, but is not limited to, a smart television, a tablet computer, an iPad, a laptop or personal computer, a Personal Digital Assistant (PDA), mobile phone, or any other handheld device. For the sake of simplicity of depiction, only one client device 130 is shown in FIG. 1. However, those skilled in the art will appreciate that the media content, the content delivery channel and the data from the headend 120 and the social media platform 110 may be provided to a plurality of client devices.

Components of system 100 may communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

Components of system 100 may communicate using any suitable network. For example, as shown in FIG. 1, components of system 100 may be configured to communicate with each other over a network 150. Network 150 may include one or more networks or types of networks capable of carrying communications and/or data signals between the components of system 100. For example, network 150 may include, but is not limited to, a cable network, an optical fiber network, a hybrid fiber coax network, a wireless network (e.g. a Wi-Fi and/or mobile telephone network), a satellite network, a wireless broadcast network (e.g., a satellite media broadcasting network or terrestrial broadcasting network), a subscriber television network, a provider-specific network, the Internet, an intranet, local area network, any other suitable network, and/or any combination or sub-combination of these networks. Lastly, although FIG. 1 shows components of system 100 communicatively coupled via network 150, those skilled in the art will appreciate that the components of system 100 may be configured to communicate with each other in any other suitable manner (e.g. via a direct connection).

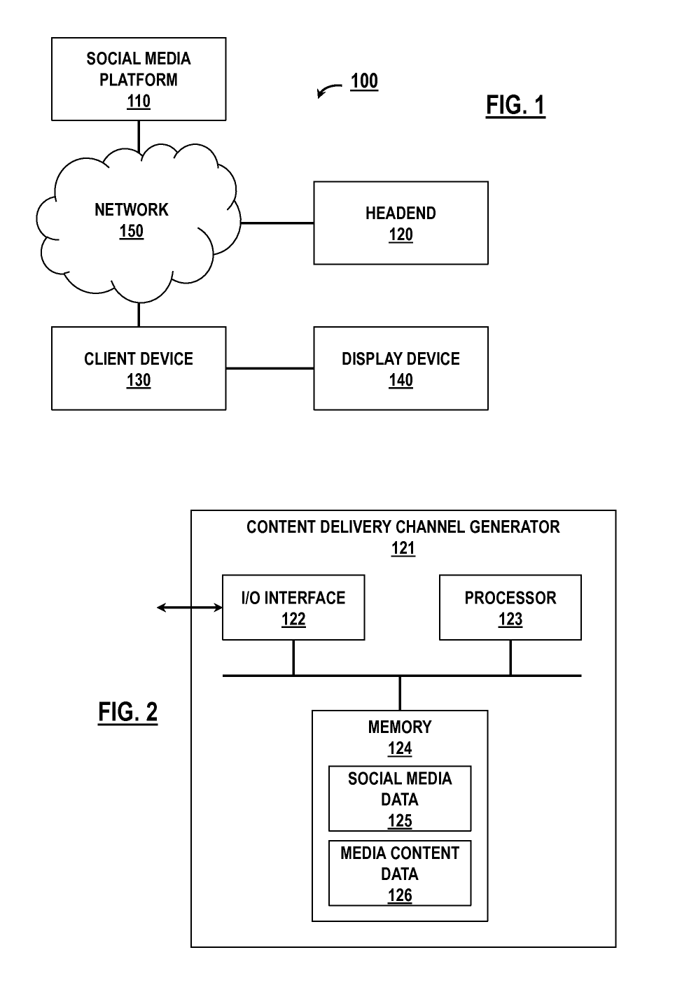

Reference is now made to FIG. 2, which is a block diagram illustration of a content delivery channel generator 121, constructed and operative in accordance with an embodiment of the present invention. The content delivery channel generator 121 is typically located at the headend 120 although those skilled in the art will appreciate that it may be located at any other suitable location as long as it is operable to communicate with the social media platform 110 and the headend 120. The content delivery channel generator 121 includes at least an input/output (I/O) interface 122, a processor 123 and a memory 124.

The I/O interface 122 may be any suitable communication interface enabling the content delivery channel generator 121 to exchange data with the social media platform 110 and the headend 120. The I/O interface 122 is further operable to pass the received data to the processor 123 and/or the memory 124.

The processor 123 is a microcontroller or a microprocessor, for example to execute software instructions stored in memory 124.

The memory 124 may comprise read only memory (ROM), random access memory (RAM), magnetic disk storage media devices, optical storage media devices, flash memory devices, electrical, optical, or other physical/tangible (e.g. non-transitory) memory storage devices. Thus, in general, memory 124 may comprise one or more computer readable storage media (e.g. memory device) encoded with software comprising computer executable instructions and when the software is executed (by the processor 123) it is operable to perform the operations described hereinbelow. For example, memory 124 stores or is encoded with instructions for:
filtering the statistics requested and received from the social media platform 110 to identify the media content instances relevant to the headend 120 the most commented on the social network; and
gathering AV content to include within the content delivery channel, the AV content corresponding to the portions of the most commented upon media content instances relevant to the headend 120 on the social network.

The memory 124 is further operable to store data such as, for example, but not limited to, social media data 125 and media content data 126. The social media data 125 may include the statistics requested and received from the social media platform 110 via the I/O interface 122 as well as intermediate and/or final data obtained during or as a result of the different operations mentioned hereinabove. The media content data 126 typically includes data relevant to the media content instances for which statistics may be requested.

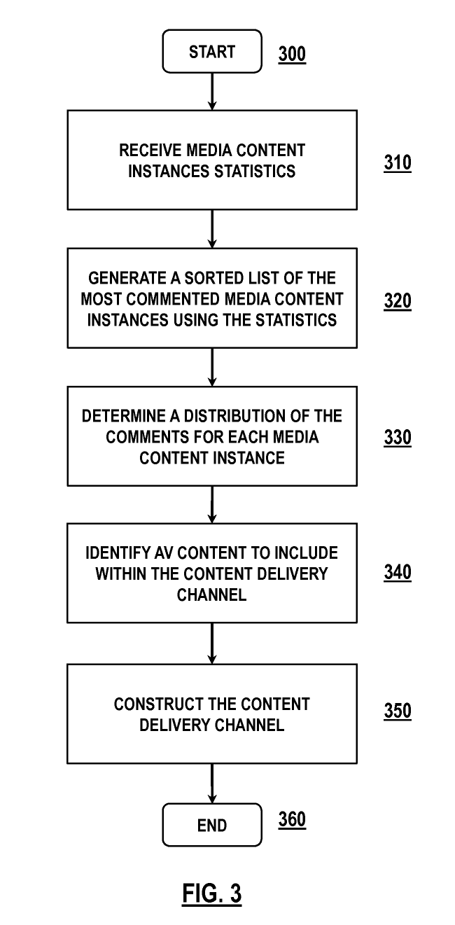

Reference is now made to FIG. 3, which is a flow chart diagram illustrating a method for generating the content delivery channel according to embodiments of the present invention. The process starts at step 300.

At step 310, the content delivery channel generator 121 receives statistics from the social media platform 110. Typically, the content delivery channel generator 121 may request the social media platform 110 to transmit statistics about comments relevant to media content instances that were broadcast during a given period of time. Those skilled in the art will appreciate that the period of time is configurable and may be set and/or changed at any time. Non-limiting examples includes transmitting and receiving statistics for media content instances that were broadcast during the current day, the last twenty-four hours, the last twelve hours, the last week, etc. Similarly, the time at which the statistics are transmitted by the social media platform 110 and received at the content delivery channel generator 121 may be configurable. Non-limiting examples include transmitting/receiving the statistics on a real time basis during the given period of time, at the end of the given period of time, or at a later time.

The media content data 126 may be used to identify the comments relevant to media content instances provided by the headend 120 on the social media platform 110. The media content data 126 identifies each of the media content instances that are made available by the headend 120 to the client device 130. The media content data 126 may comprise for example, but not limited, an official hash tag associated with a particular media content instance, a user-generated hash tag associated with a particular media content instance, a title of the media content instance, a name of one or more characters/actors associated with the media content instance, etc. or any other suitable attribute enabling a media content instance to be identified in the comments published on the social media platform 110. The media content data 126 may be received and/or retrieved from a metadata provider (not shown in FIGS. 1 and 2), a third-party entity, and/or any of the components of system 100.

In one example embodiment, official and user-generated hash tags may be received and/or retrieved from the social media platform 110. Taking an episode of the series “Games of Thrones” as an example, the official hash tag associated with this media content instance is #got. However, other hash tags generated by users of the social media platform 110 (e.g. #GamesOfThrones) might appear. In order to take into consideration the user generated hash tags (e.g. #GamesOfThrones) a threshold value may be defined and applied. In turn, when the official hash tag #got is associated with the user-generated hash tag #GamesofThrones more than the threshold value, the user-generated hash tag is provided and stored at the content delivery channel generator 121. As a result, both hash tags may be used as media content data 126 for the particular media content instance. In another example, the titles, names, etc. may be received and/or retrieved from the headend 120. For example, a heuristic search may be performed through the Electronic Program Guide (EPG) to identify titles, names of characters/actors, etc. relevant to each media content instance broadcast within the given period of time. As a result, the titles, the names, etc. may be used as media content data 126 for the media content instances.

In any case, the comments relevant to the media content instances of the headend 120 are identified using the media content data 126. Then, statistics may be transmitted by the social media platform 110 and received at the content delivery channel generator 121. These statistics may be provided to the content delivery channel generator 121 in any suitable form and stored in memory 124. Typically, for each comment identified as relevant to a media content instance, an entry is created comprising at least one identifier indicating to which media content instance the entry refers to, and a timestamp corresponding to a data and/or a time at which the comment was published on the social media platform 110. The statistics received by the content delivery channel generator 121 may therefore be seen as a collection of entries that are stored in the memory 124 as part of the social media data 125.

Then, these statistics are processed at step 320. The processor 123 is able to determine which media content instances were the most commented upon on the social media platform 110 during the given period of time. The processor 123 parses the statistics and increments a media content instance count value every time an identifier corresponding to a media content instance is found. Upon completion, the processor 123 generates a list of the media content instances sorted from a highest to a lowest count value for the given period of time. In other words, the list of the media content instances is sorted from a most to a least commented upon media content instances for the given period of time. In another example embodiment, the sorting operation may be based on other data such as historical data. For example, a previous, past, or average, etc. count value for a media content instance may be compared to the current count value for the same media content instance. The difference between previous, past or average and current count values may therefore be computed and used as the basis for the sorting operation. In any case, the generated list is then stored in memory 124 as part of the social media data 125.

At this step 330, the processor 123 continues to process the received statistics. While parsing each media content instance, the processor 123 is further able to determine a distribution of the comments for the period of time during which a media content instance was broadcast. The processor 123 may receive and/or retrieve the media content instance broadcast start and end times from the headend 120. For each media content instance, the processor 123 compares the timestamps relevant to the media content instance with the media content instance broadcast start and and times. As a result of this comparison, the processor 123 determines which timestamps to use for calculating a number of comments published per unit of time. A timestamp corresponding to a time not comprised between the media content instance broadcast start and end times is not taken into consideration for the calculation. The unit of time may be set to one minute although those skilled in the art will recognize that any suitable unit of time may be chosen. At the end, the distribution of the comments is calculated for each media content instance and stored in memory 124 as part of the social media data 125.

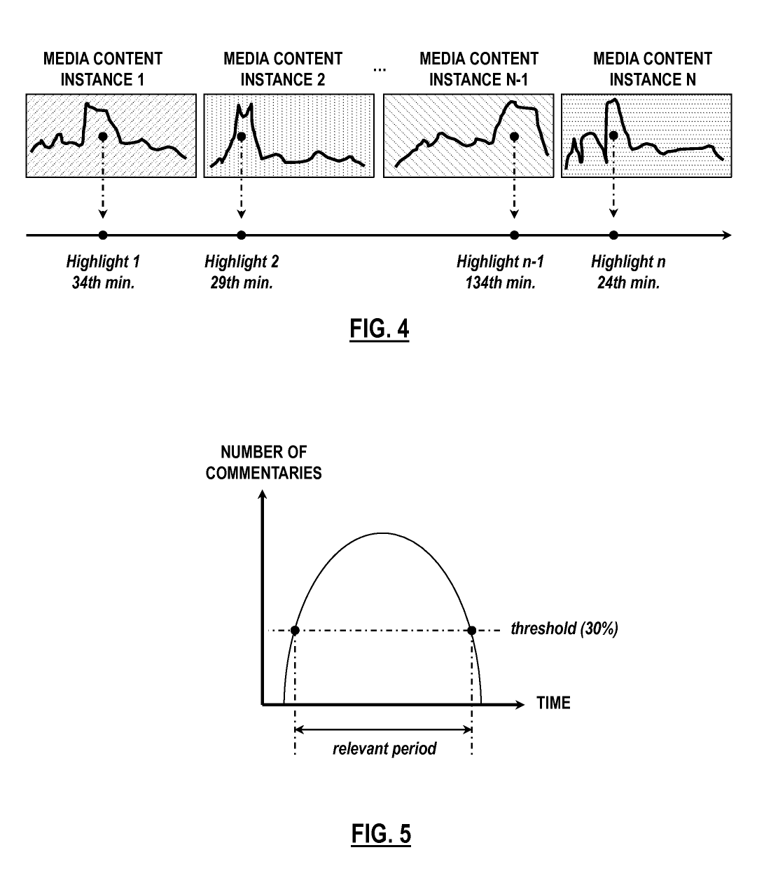

Reference is now made to FIG. 4, which is a graphical illustration showing different distributions of comments for different media content instances in accordance with an embodiment of the present invention. FIG. 4 shows four different media content instances 1, 2, N-1 and N for which comments were published on a social media platform 110. Media content instance 1 corresponds to the most commented media content instance whereas media content instance N is the least commented. For each of them, a graphical representation defining a trend corresponding to the distribution of comments published on the social media platform 110 between media content instance start and end times may be generated using the number of comments published per unit of time and stored in memory 124 as part of the social media data 125.

Then, the process moves to step 340 in which the processor 123 of the content delivery channel generator 121 identifies the AV content that is to be included within the content delivery channel. The AV content to include generally corresponds to the highlights of the media content instances, where heightened activity is a proxy for a highlight. As illustrated in FIG. 4, during each media content instance, a moment might appear that is comment worthy. Such moments are represented in the peaks within each distribution of comments of the media content instances. For example, media content instance 1 may be a soccer game and the peak may correspond to a goal scored by one of the teams that was extensively commented on the social media platform 110 (i.e. highlight 1 as shown in FIG. 4). Similarly, media content instance N-1 may be an episode of a series and the peak may correspond to a final twist of the plot that was extensively commented on the social media platform 110 (i.e. highlight n-1 as shown in FIG. 4).

In one example embodiment, for each media content instance, the number of comments published per unit of time is compared to a configurable threshold. This configurable threshold may be set to a particular value corresponding to a particular number of comments published per unit of time, although those skilled in the art will appreciate that it may be changed and/or updated at any time. Then, for each media content instance, the processor 123 is able to determine the highlights for which a number of comments per unit of time is over the threshold. Start and end times of the highlights may be determined using the timestamp associated with the entries. For each highlight, the processor 123 is able to identify the earliest entry for the first unit of time for which the number of comments is over the threshold (i.e. the entry corresponding to the comment published the earliest for this unit of time on the social media platform 110) and set the timing information associated with the earliest entry as the highlight start time. Similarly, the processor 123 is able to identify the latest entry for the last unit of time for which the number of commentaries is over the threshold (i.e. the entry corresponding to the commentary published the latest for this unit of time on the social media platform) and set the timing information associated with the latest entry as the highlight end time. At the end, the highlights of the different media content instances are identified for which corresponding AV contents are to be included within the content delivery channel.

In order to identify the AV content corresponding to each highlight, the processor 123 is able to use the media content instances broadcast start time. Since the comments relevant to a highlight are published on the social media platform approximately at the same time (or quickly after that time) as the time at which the highlight of the media content instance is broadcast, the highlight start and and times may be approximated as the corresponding AV content start and end times. The corresponding AV content start and and times are then converted into offset start and and times relative to the media content instance broadcast start. The offset start time of the AV content may be expressed as a duration corresponding to the time elapsed between the media content instance broadcast start time and the determined highlight start time. Similarly, the offset end time of the AV content may be expressed as a duration corresponding to the time elapsed between the media content instance broadcast start time and the determined highlight end time. Additionally and/or alternatively, a guard interval of a particular duration may be applied to AV content offset start and end times to ensure that the highlight is entirely captured. The following example illustrate these mechanisms:
determined highlight start time: 4:32 pm;
determined highlight end time: 4:36 pm;
media content instance start time: 4:00 pm; and
guard interval: 1 minute.
   Then, we have:
calculated AV content offset start time: 32 mns; and
calculated AV content offset end time: 36 mns.
   With the guard interval being applied, we have:
calculated AV content offset start time: 31 mns; and
calculated AV content offset end time: 37 mns
   At the end, the corresponding AV contents to include within the content delivery channel are identified.

Alternatively and/or additionally, the corresponding AV content start and and times may be determined using one or more media content instance timeline metadata. Generally, program metadata is typically associated with media content instance. Common examples of such program metadata include a title, a synopsis, a genre, one or more images and cast information relating to a specific item of television program content. Media content instance timeline metadata corresponds to metadata that is associated with one or more points along the timeline of a particular media content instance, rather than being associated with the entire media content instance as a single atomic entity. Media content instance timeline metadata may therefore be suitable for providing information relevant to a specific point during a media content instance. For example, whereas program specific metadata such as that used to generate an EPG may indicate that the genre of a television program is a movie, media content instance timeline metadata may be used to indicate, for example, but not limited to, a specific time during the course of the movie, such as, for example, when a particular commercial, video scene, etc. actually begins or ends. Those skilled in the art will appreciate that the media content instance timeline metadata may be configured according to the genre of a particular media content instance to indicate specific points in time during the course of the particular media content instance.

The processor 123 of the content delivery channel generator 121 may receive and/or retrieve timeline metadata for each media content instance and use it to determine an AV content start and/or end time. For example, the processor 123 may be operative to identify that the determined highlight start and end times fall between two specific points in time indicated by the media content instance timeline metadata corresponding to a commercial. In such a case, it is likely that the highlight of interest is the commercial itself. Therefore, the processor 123 may use the specific points in time of the media content instance timeline metadata as the AV content start and end times. In another example, the processor 123 may be operative to identify that the determined highlight end time falls between two specific points in time indicated by the media content instance timeline metadata corresponding to a particular video scene. In such a case, it is likely that the highlight of interest is just before the particular video scene indicated by the media content instance timeline metadata. The processor 123 may therefore use the specific point in time corresponding to the video scene start time of the media content instance timeline metadata as the AV content end time. Those skilled in the art will appreciate that the above examples are not limiting and that other ways of using a media content instance timeline metadata to set AV content start and/or end times may be provided. The content delivery channel generator 121 may be configured to use rules in accordance with the genre (or other program metadata) to further specify an AV content start and/or end time according to media content instance timeline metadata. For example, for a movie, the timeline metadata may be used to specify an entire video scene; for a commercial break, the timeline metadata may be used to specify the commercial advertisement itself; for a sports event, the timeline metadata may be used to specify a specific play or sequence of plays, etc.

Reference is now made to FIG. 5, which is graphical illustration showing a peak of a graphical representation of the distribution of the commentaries in accordance with another example embodiment of the present invention. The graphical representation generated for each media content instance may be used to identify the AV content to include within the content delivery channel. Each peak of a graphical representation may be represented with a Gaussian shape (as shown in FIG. 5) centered on the top point corresponding to the unit of time for which the number of comments published on the social media platform 110 is the highest. Then, the processor 123 is able to determine a portion of the peak (e.g. a relevant period or highlight) for which a number of comments per unit of time is over the configurable threshold. The processes for determining the highlights start and and times and the corresponding AV content start and end times are the same as the ones described hereinabove. At the end, the corresponding AV contents to include within the content delivery channel are identified.

In both embodiments described hereinabove, the threshold is set to a particular value corresponding to a particular number of comments published per unit of time. This configurable value may be set as a fixed constant value or may be defined as a relative value. In the latter case, the relative value may be defined as a percentage relative to the highest number of comments received in one unit of time during the given period of time. For example, it may be decided that every unit of time in which the number of comments is more than thirty percent of the highest number of comments received in one unit of time is to be considered as a highlight. FIG. 5 illustrates this example in which the threshold is net to 30% and the highlight start and end times are calculated based on this relative value for the threshold. Anything that is above 30% of the maximum peak is considered as a highlight.

In another example, the relative value may be defined as a percentage relative to an average of the total number of comments relevant to a media content instance that were published on the social media platform 110 during the media content instance broadcast start and end times. For instance, it may be decided that every unit of time in which the number of comments are over twenty five percent of the average is to be considered as a highlight. In the embodiment for which the graphical representations are used, each Gaussian peak that is over 25% of the average is considered as a highlight. Additionally and/or alternatively, a same or different threshold(s) may be used to determine the highlights for the different media content instances. Referring again to FIG. 4. a fixed constant value may be used as the threshold for media content instances 1 and 2 while a relative value may be used as the threshold for media constant instances N and N-1. As a result, zero, one or more highlights may be identified for the different media content instances.

At step 350, the processor 123 constructs the content delivery channel. The processor 123 retrieves, from memory 124, the list generated at step 320 and gathers the relevant AV contents to include within the content delivery channel. Based on the AV content offset start and end times, the processor 123 may be able to retrieve the corresponding AV contents from any suitable content source. The corresponding AV contents may be retrieved from, for example, but not limited to, the headend 120 catch-up catalog, a third-party content provider, a cloud-based computing system, or any other external AV content source accessible by the content delivery channel generator 121.

The processor 123 parses the sorted list and starts with the first media content instance in the list, i.e. the most commented upon instance (for example, media content instance 1 of FIG. 4). The processor 123 uses the AV offset start and end times to retrieve the AV contents corresponding to the highlights of media content instance 1. Once completed, or once it is determined that no highlights were identified for this particular media instance, the processor 123 selects the following media content instance in the list (e.g. media content instance 2 in FIG. 4) and perform the same operations. The process is performed for each media content instance in the list.

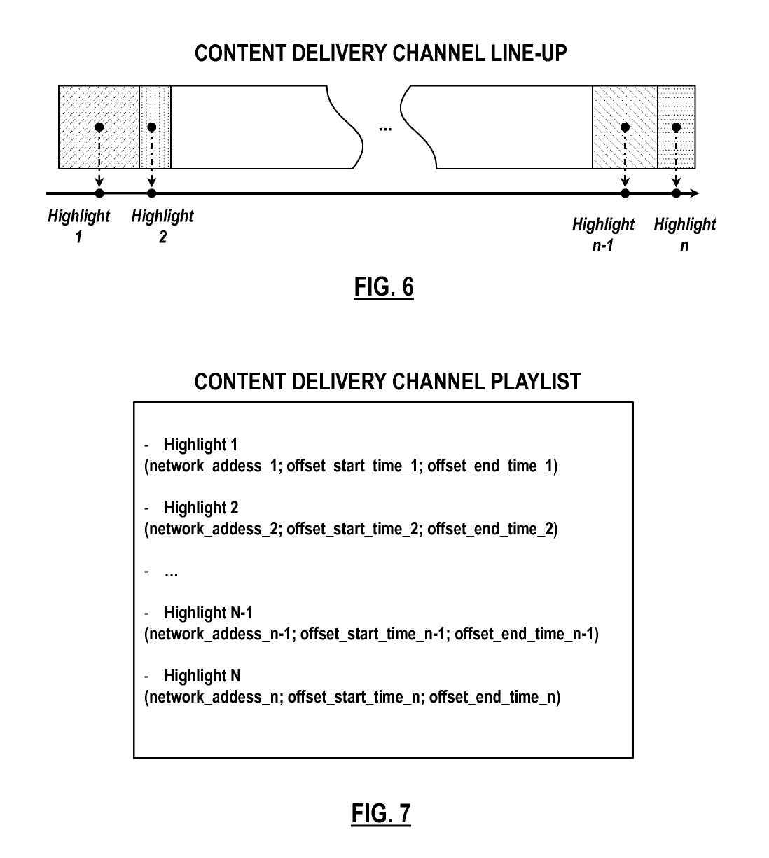

Thus, the content delivery channel is constructed with the retrieved AV contents. The result of the process is shown in FIG. 6, to which reference is now made. FIG. 6 is a pictorial illustration of the content delivery channel line-up, constructed and operative in accordance with embodiments of the present invention. The first AV content corresponds to a highlight of media content instance 1 and is placed in first position of the content delivery channel line-up. The second AV content corresponds to a highlight of media content instance 2 and is placed in second position of the content delivery channel line-up, etc. The last AV content placed in the last position of the content delivery channel line-up corresponds to a highlight of media content instance N. Although described as referring to different media content instances, those skilled in the art will appreciate that different highlights may be relevant to a same content instance. For example, in a situation where more than one highlight is identified for a single media content instance, highlight 1 may refer to a first highlight of media content instance 1 and highlight 2 may refer to a second highlight of media content instance 1.

Additionally and/or alternatively, the corresponding AV contents are not retrieved but rather references are produced. Each of this reference typically includes a location indicating the content source for the AV content (e.g. a network address, a Uniform Resource Locator, a pointer, etc.) and the offset start and end times indicating the portion of the AV content to include within the content delivery channel. Therefore, the same process may be applied but, instead of constructing a channel line-up, a playlist is constructed for the content delivery channel.

The result of the process is shown in FIG. 7, to which reference is now made. FIG. 7 shows a playlist for the content delivery channel, constructed and operative in accordance with embodiments of the present invention. The first AV content corresponds to a highlight of media content instance 1 and is placed in first position of the content delivery channel playlist. The second AV content corresponds to a highlight of media content instance 2 and is placed in second position of the content delivery channel playlist, etc. The last AV content placed in the last position of the content delivery channel playlist corresponds to a highlight of media content instance N. Although described as referring to different media content instances, those skilled in the art will appreciate that different highlights may be relevant to a same content instance. For example, in a situation where more than one highlight is identified fore single media content instance, highlight 1 may refer to a first highlight of media content instance 1 and highlight 2 may refer to a second highlight of media content instance 1.

The process ends at step 360 at which the content delivery channel is constructed and made available to one or more users of client device 130.

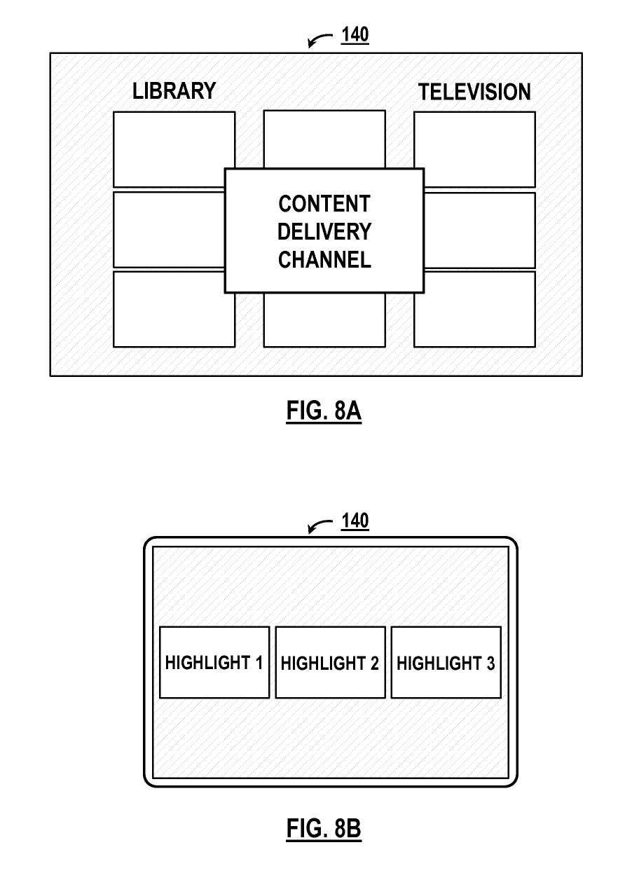

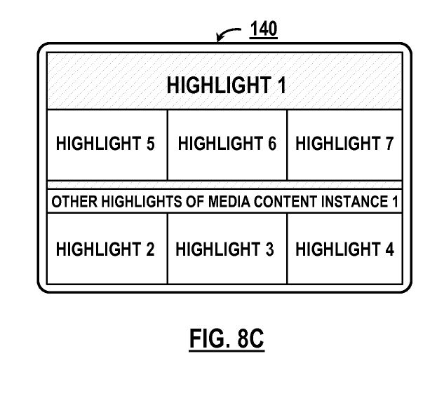

Reference is now made to FIG. 8A, which is a pictorial illustration of a user interface for accessing the content delivery channel, in accordance with an embodiment of the present invention.

Once generated, the content delivery channel is ready to be broadcast and made available to one or more users of client device 130. FIG. 8A shows an EPG displayed on a display device 140 (e.g. a TV set) associated with client device 130. The EPG is represented as a mosaic screen comprising a plurality of video tiles. Each video tile surrounding the content delivery channel tile corresponds to a particular media content selectable and accessible by a user of client device 130 such as, an event on a live broadcast channel, a recorded event stored on a memory of the client device 130, a video-on-demand asset, etc. The content delivery channel is shown in the middle of the EPG as being selectable and accessible by the user.

The user may select the content delivery channel using any suitable controller such as for example, but not limited to, a remote control, a mobile phone, a handheld device, a tablet computer, etc. Once selected, the content delivery channel is played back and displayed on display device 140. The content delivery channel is played back according to the content delivery channel line-up (FIG. 6) and/or the content delivery channel playlist (FIG. 7). Therefore, the playback starts with the AV content corresponding to the first highlight of the most commented media content instance on the social platform 110. Then, the playback continues with another AV content which may be a second highlight of the most commented media content instance and/or a first highlight of the second most commented media content instance on the social platform 110. During each transition between the highlights, additional information (e.g. media content instance name, broadcast time, channel, etc.) may be displayed. Also, different actions/functions may be made available to the user while watching the content delivery channel. Non-limiting examples of actions include: accessing more information on the media content instance; record a future replay of the media content instance; access and view the media content instance in its entirety; fast-forward and fast-rewind; jump to the next or another highlight; view the channel line-up and/or playlist; etc.

Reference is now made to FIGS. 8B and 8C, which are pictorial illustrations of user interfaces showing the content delivery channel line-up and/or playlist, in accordance with embodiments of the present invention.

FIG. 8B shows a first example of the content delivery channel line-up and/or playlist as displayed on a viewing device. The viewing device may be suitable computing device comprising a display screen and at least one processor such as, for example, but not limited to, a tablet computer, a laptop or desktop computer, a smartphone, a handheld device, etc. The user may run a ‘Content delivery channel’ application on the viewing device and, as a result, the content delivery channel is displayed on a display screen of the viewing device. In FIG. 8B, three video tiles are shown on the display screen of the viewing device corresponding to the three first highlights of the content delivery channel. For example, video tiles for highlight 1 relevant to media content instance 1, highlight 2 relevant to media content instance 2 and highlight 3 relevant to media content instance 3 may be shown and rendered on the display screen of the viewing device. The user can select a video tile and also navigate the content delivery channel line-up and/or playlist by applying well-known gestures (e.g. left swipe, right swipe, etc.) directly on the display screen of the viewing device. Typically, a left swipe gesture may result in having the next highlights (e.g. highlights 4, 5, . . . , N) being displayed. Selecting a particular video tile may result in playing the AV content of the highlight associated with the video tile. Those skilled in the art will appreciate that any suitable video tiles arrangement may be used to display the different highlights. For example, the highlights may be shown in a mosaic arrangement as shown in FIG. 8A or in a column arrangement (instead of the row arrangement shown in FIG. 8C). Similarly, the size of the video tiles may be chosen so that, for example, all the highlights of the media content instances are shown on a single screen or a predefined number of highlights are shown in a single screen.

FIG. 8C shows a second example of the content delivery channel line-up and/or playlist as displayed on the display screen of the viewing device. In this example, highlight 1 corresponding to media content instance 1 is played in the background while a plurality of video tiles are shown on top of it. In this example, a first row comprising three video tiles relevant to highlights 5, 6 and 7 and a second row comprising three video tiles relevant to highlights 2, 3 and 4 are shown. This arrangement is particularly useful when more than one highlight is identified for a single media content instance. Typically, highlights 1, 2, 3 and 4 are relevant to a same media content instance whereas highlights 5, 6 and 7 are relevant to different media content instances. Such a display of the content delivery channel line-up and/or playlist typically enables the user to understand how the content delivery channel is constructed and which highlights are available and accessible within the content delivery channel. In turn, the user may decide to jump to another highlight by selecting one of the video tiles.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for providing access to a content delivery channel for presentation on a viewing device, said method comprising:
receiving statistics about comments published on a social media platform, said comments being identified as relevant to a plurality of media content instances broadcast during a given period of time;
processing said received statistics to determine the most commented upon media content instances on said social media platform;
using said processed statistics to identify one or more highlights in each of said most commented upon media content instances; and
constructing a content delivery channel, wherein said content delivery channel comprises audio-visual (AV) content corresponding to said identified one or more highlights.

2. The method of claim 1, wherein said statistics comprise, for each comment being identified as relevant to one of said plurality of media content instances, at least one identifier identifying a media content instance and a timestamp corresponding to a time at which said comment is published on said social media platform.

3. The method of claim 2, wherein said processing comprises:
parsing said received statistics;
counting, for each of said plurality of media content instances, a number of identifiers found during said parsing; and
ranking said plurality of media content instances from a most to a least commented media content instance using said counted number of identifiers.

4. The method of claim 3, wherein said using comprises:
parsing said received statistics;
determining, for each of said most commented upon media content instances, a distribution of comments using counted number of identifiers and said timestamps, said distribution of comments being relevant to the period of time during which a media content instance was broadcast; and
using said determined distribution of comments to identify, for each of said most commented upon media content instances, one or more highlights for which said number of comments published per unit of time is over a configurable threshold.

5. The method of claim 4, wherein said determining comprises calculating, for each of said most commented upon media content instances, a number of comments published per unit of time using timestamps comprised between a media content instance broadcast start time and a media content instance broadcast end time.

6. The method of claim 4, wherein a same configurable threshold is used for each of said most commented upon media content instances.

7. The method of claim 6, wherein said configurable threshold is defined as a constant value corresponding to a particular number of comments published per unit of time.

8. The method of claim 6, wherein said configurable threshold is defined as a relative value corresponding to at least one of the following:
a percentage relative to a highest number of comments received for a particular media content instance in one unit of time; or
a percentage relative to an average number of comments received for a particular media content instance.

9. The method of claim 4, wherein different configurable thresholds are used for each of said most commented upon media content instances.

10. The method of claim 9, wherein said configurable threshold is defined as a constant value corresponding to a particular number of comments published per unit of time for each of said most commented upon media content instances.

11. The method of claim 9, wherein said configurable threshold is defined as a relative value corresponding to at least one of the following:
a percentage relative to a highest number of comments received in one unit of time for each of said most commented upon media content instances; or
a percentage relative to an average number of comments received for each of said most commented upon media content instances.

12. The method of claim 4, wherein said using comprises:
determining, for each of said one or more highlights, highlight start and end times using said timestamps; and
identifying AV content corresponding to each of said one or more highlights using said determined highlight start and end times.

13. The method of claim 12, wherein said determined highlight start time corresponds to a first unit of time for which a number of comments published on said social media platform for a media content instance is over said configurable threshold and said determined highlight end time corresponds to a last unit of time for which said number of comments published on said social media platform is over said configurable threshold.

14. The method of claim 13, further comprising retrieving a media content instance broadcast start time; and said identifying AV content comprises calculating AV content start and end times using said determined highlight start and end times and said retrieved media content instance broadcast start time, wherein:
said AV content start time is calculated as a difference between said determined highlight start time and said retrieved media content instance broadcast start time; and
said AV content end time is calculated as a difference between said determined highlight end time and said retrieved media content instance broadcast start time.

15. The method of claim 14, wherein a guard interval is subtracted to said calculated AV content start time.

16. The method of claim 15, wherein said guard interval is added to said calculated AV content end time.

17. The method of claim 12, wherein said constructing comprises:
retrieving, for each of said one or more highlights, said identified AV content using said calculated AV content start and end times; and
constructing said content delivery channel by gathering said retrieved AV contents corresponding to each of said one or more highlights in a content delivery channel line-up.

18. The method of claim 12, wherein said constructing comprises:
producing, for each of said one or more highlights, a reference comprising a location and start and end times of said corresponding AV content; and
constructing a content delivery channel by generating a content delivery channel playlist comprising said produced references.

19. An apparatus comprising:
a communication interface operable to receive statistics about comments published on a social media platform, said comments being identified as relevant to a plurality of media content instances broadcast during a given period of time by a headend; and
a processor operable to:
process said received statistics to determine the most commented upon media content instances on said social media platform;
use said processed statistics to identify one or more highlights in each of said most commented upon media content instances; and
construct a content delivery channel, wherein said content delivery channel comprises audio-visual (AV) content corresponding to said identified one or more highlights.

20. A user interface comprising:
a display screen of a viewing device operative to render a plurality of video tiles, wherein each of said video tiles represents AV content corresponding to a highlight of a particular media content instance, said highlight being identified after receiving and processing statistics about comments relevant to said particular media content instance published on a social media platform; and
a processor operable to receive input signals from a user of said viewing device, said input signals corresponding to a user interacting with one of said plurality of video tiles, said processor being further operable, in response to said received input signals, to play said AV content associated with said one of said plurality of video tiles.
